(19) United States
(12) Patent Application Publication
(10) Pub. No.: US 2003/0046206 A1
(43) Pub. Date: Mar. 6, 2003

(54) Bond to be issued for the purpose of acquiring private funds to be invested in public works and a new market forming method that encourages bond investors

(76) Inventor: Michihiro Sato, Tokyo (JP)

Correspondence Address: Richard C. Woodbridge, Esq., Woodbridge & Associates, P.C., P.O. Box 592, Princeton, NJ, 08542-0592, US

(21) Appl. No.: 10/233,995

(22) Filed: Aug. 30, 2002

(30) Foreign Application Priority Data
Sep. 3, 2001 (JP) 2001-265178

(51) Int. Cl. G06F 17/60

(52) U.S. Cl. 705/35

(57) ABSTRACT

A bond to be issued by bond issuers for the purpose of acquiring private funds to be invested in public works such as infrastructure improvement projects wherein the bond is constituted to include wordings that a national or local government warrants the bond issuers' principal and interests repayment liabilities to certain limits. Thus the invention provides a bond issued for the purpose of acquiring private funds to be invested in public works such as infrastructure improvement projects in order to promote improvements of infrastructures even under a tight financial condition.

### BACKGROUND OF THE INVENTION

1. Field of the Invention

The present invention relates to a bond to be issued for acquiring private funds, in particular, for inviting private investments in public works such as infrastructure improvement projects.

The term “public works” as it is used herein includes not only public works in the conventional sense, i.e., public works that are planned solely by a national or local government and executed solely by a national or local government, but also public works that are planned solely by a private enterprise and executed solely by a private enterprise; public works that are planned solely by a national or local government and executed solely by a private enterprise; public works that are planned solely by a private enterprise and executed solely by a national or local government; public works that are planned solely by a national or local government and executed jointly by a national or local government and a private enterprise; public works that are planned solely by a private enterprise and executed jointly by the a national or local government and a private enterprise; public works that are planned jointly by a national or local government and a private enterprise and executed solely by a national or local government; public works that are planned jointly by a national or local government and a private enterprise and executed solely by a private enterprise; and public works that are planned jointly by a national or local government and a private enterprise and executed jointly by a national or local government and a private enterprise.

The term “infrastructure improvement projects” as it is used herein includes, but is not limited to, constructions and operations of public facilities such as roads, railways, harbors, airports, rivers, parks, public water supply systems, public sewage systems, and public industrial water supply systems; constructions and operations of facilities for government uses such as government buildings and housings; constructions and operations of facilities for public benefits such as public housings, educational and cultural facilities, waste processing facilities, healthcare facilities, social benefit facilities, welfare facilities, parking facilities, and underground commercial facilities; constructions and operations of information and communication facilities, heat energy supply facilities; new energy facilities; recycling facilities (except waste processing facilities), sightseeing facilities, and research facilities; and constructions and operations of commercial buildings annexed to railway stations and other commercial buildings.

2. Description of Related Art

Constructions and operations of public facilities such as roads and railroads, facilities for public benefits such as healthcare facilities and social benefit facilities are of great concerns of the residents who live in the related area, as they affect the basics of their life. It is difficult for them to walk or drive without decent roads. It is impossible for them to receive healthcare if there are no hospitals and other healthcare facilities when they get sick.

Therefore, those who live in an area where facilities that affect the basics of residents' life, i.e., infrastructures (basic facilities of a society) are poor try to move to another area where infrastructures are better. This creates a tendency for population concentration in big cities where those infrastructures are well established, for example, Tokyo and Osaka in case of Japan. The concentration of population causes problems such as longer commuting time, higher rents, smaller living quarters, and excessive traffic congestions.

Thus, each country of the world is planning to improve infrastructures such as roads and healthcare facilities in various regions in the country, but it is also true that the governments are experiencing severe financial tightness everywhere in the world in recent years. Thus they are having difficulties in financing public works such as infrastructure improvement projects from tax revenues alone. It is indispensable to infuse some private funds into public works such as infrastructure improvement projects in order to alleviate the burden on tax money under the current financial tightness.

As a means of acquiring private funds for investments in public works, a national or local government issues bonds. Bonds are essentially negotiable papers issued for acquiring funds from a wide range of citizens. If issuers of bonds are a national or local government or an organization related to a government, the bonds are called public bonds.

In such public bonds, there has been a type of bonds issued by a national or local government for the purpose of acquiring private funds for public works such as infrastructure improvement projects. Such bonds are called government guaranteed bonds. Government guaranteed bonds are bonds whose issuer's liabilities for the repayment of the principal and related interests are guaranteed by the pertinent government.

On the other hand, bonds whose issuers are a private enterprise are called industrial bonds. Industrial bonds include bonds related to the SPC Law (Law concerning Liquidation of Special Assets of Special Purpose Company).

Bonds covered by the SPC Law are bonds related to so-called “project finance.”Bonds related to project finance are bonds issued for acquiring funds for executing a specific project. For example, if the use of the capital acquired by a bond issued in relation to the construction and operation of a commercial building to be erected in front of a railway station is specified for the project of “construction and operation of the station front building,” said bond is regarded as a bond related to the project finance and a bond related to the SPC Law.

FIG. 3 shows an example of a bond related to the SPC Law, i.e., a bond related to project finance. On the face of the bond certificate related to the SPC Law shown in FIG. 3, a wording 22 of “Construction & Operation Bond for Y Station Front Building,” a wording 23 of “20 Years,” a wording 24 of “¥100,000,” a wording 25 of “The redemption payment for this bond shall be available in exchange for this certificate at X Bank's main office or at any of its branch or agent,” a wording 26 of “If the redemption date happened to be a bank holiday, the payment shall be made on the next business day,” a wording 27 of “The bond shall be void in 10 years from the day after the redemption date,” a wording 28 of “Registration and replacement of the bond certificate for reasons of soiling or damage or any other handling of the bond certificate shall be available at X Bank's main office or at any of its branch or agent,” a wording 29 of “Issuing Date: April 1, 2002,” and a wording 30 of “Redemption Date: Mar. 31, 2022 ” are written.

The wording 22 of “Construction & Operation Bond for Y Station Front Building” indicates that this bond is a bond covered by the SPC law. In other words, the wording 22 clarifies that the bond relates to the construction and operation of the station front building.

The wording 23 of “20 Years” indicates that the principal and the interest shall be redeemable in 20 years from the issuing date. The wording 24 of “¥100,000” indicates the amount of fund obtained by the issue of this bond. The wording 25 of “The redemption payment for this bond shall be available in exchange for this certificate at X Bank's main office or at any of its branch or agent” clarifies the locations of redemption. The wording 25 also clarifies that the principal and the interest will be paid in exchange for the bond certificate.

The wording 26 of “If the redemption date happened to be a bank holiday, the payment shall be made on the next business day” clarifies the payment shall be made on the next business day as it is not clear when the payment of the principal and the interest will be made if the redemption date falls on a bank holiday.

The wording 27 of “The bond shall be void in 10 years from the day after the redemption date” clarifies that the bond shall be void after a period. The wording 28 of “Registration and replacement of the bond certificate for reasons of soiling or damage or any other handling of the bond certificate shall be available at X Bank's main office or at any of its branch or agent,” clarifies how the bond certificate is handled in case of need for registration and replacement of the bond certificate for reasons of soiling or damage.

The wording 29 of “Issuing Date: Apr. 1, 2002 ” clarifies the issuing date. The wording 30 of “Redemption Date: Mar. 31, 2022 ” clarifies the redemption date.

While bonds covered by the SPC Law, for example, bonds such as the one shown in FIG. 3 for project financing, in particular, for projects of public works such as infrastructure improvements by a private enterprise have not be heard of, those for projects such as operations of hotels by a private enterprise or operations of rental commercial buildings by a private enterprise have been well known.

FIG. 4 is a diagram showing PFI (public finance initiative; improvement of social funds using private funds). PFI is intended to efficiently and effectively improve social funds by means of promoting constructions, maintenances and operations (including planning thereof) of public facilities utilizing private funds, management capabilities and technological capabilities so as to contribute to healthy development of national economy (Article 1 of Law concerning Promotion of Improvement of Public Facilities, etc., Utilizing Private funds, etc.). The relation between a private enterprise, a national or local government, residents, and banks, securities companies, etc. (hereinafter called “financial institutions”) in a scheme of PFI is as shown in FIG. 4.

A private enterprise prepares funds (32) by borrowing money from a financial institution, executes construction and operation of a public facility such as a road, a prison, or public housing (33) to provide public services to residents (34). A national or local government pays considerations (35) to said private enterprise for the services the enterprise provides to the residents on behalf of the national or local government. For example, if the public service is the operation of a prison, the national or local government pays considerations (35) to the private enterprise for operating the prison on behalf of the national or local government.

The residents receive the services (34) provided by said private enterprise and pay the considerations (36) for the services or service fees, and the private enterprise obtains income/profit (37) through its involvement in the public works. The residents in return deposit money (31) in the financial institution, and the financial institution lends money as investment (32) to the private enterprise and receives the repayment of the capital and the payment of the interest.

Thus, PFI is a means, which has been known for private institutions for obtaining funds from private financial institutions for the purpose of conducting public works such as infrastructure improvement projects. Also known in PFI is a method of obtaining funds through bond issues instead of borrowing money from financial institutions.

However, there is a problem as shown below in the above-mentioned government guaranteed bonds, project finance bonds and PFI. For example, in case of government guaranteed bonds, a government guarantees the bond issuer's liabilities of repayment of principals and interests, but there is no limit to the degree of guarantee, so that it ends up wasting a large some of tax money in fulfilling its guaranteed obligations. Therefore, it is difficult to improve necessary infrastructures using government guaranteed bonds under a tight financial condition.

In case of project finance bonds, there is a problem that bond buyers are generally reluctant in buying bonds intended for public works projects to be executed by a private enterprise, because, when a private enterprise, which issued project finance bonds, fails in operating public works and the performance deteriorates, there is no guaranty for repayment to the buyers of said project finance bonds. Therefore, it is also difficult to improve necessary infrastructures using project finance bonds as well under a tight financial condition.

Moreover, in case of PFI, investments by financial institutions to a private enterprise are generally insufficient, because the credibility of a private enterprise, which engages in risky public works, is generally too low. Therefore, it is difficult to introduce private funds into public works through PFI because there is no guaranty for repayment for the bond issuers' liabilities for principal and interest repayment liabilities similar to the case of project finance bonds. Hence it is also difficult to improve necessary infrastructures using PFI under a tight financial condition.

### SUMMARY OF THE INVENTION

Noting these problems, the present invention intends to provide bonds to be issued for the purpose of acquiring private funds to be invested in public works such as infrastructure improvements so that infrastructure improvements can be implemented even under a tight financial condition.

Said task can be achieved by the means described in the claims. The invention described in claim 1 provides a bond to be issued for the purpose of acquiring private funds to be invested in public works which include infrastructure improvement projects, characterized in containing a wording that a national or local government warrants the bond issuer's liability for the repayment of the principal and interest to fixed limit.

The invention described in claim 2 provides the bond according to claim 1, wherein said public works are planned solely by a national or local government and executed solely by a national or local government.

The invention described in claim 3 provides the bond according to claim 1, wherein said public works such as infrastructure improvement projects are planned solely by a private enterprise and executed solely by a private enterprise.

The invention described in claim 4 provides the bond according to claim 1, wherein said public works are planned solely by a national or local government and executed solely by a private enterprise.

The invention described in claim 5 provides the bond according to claim 1, wherein said public works are planned solely by a private enterprise and executed solely by a national or local government.

The invention described in claim 6 provides the bond according to claim 1, wherein said public works are planned solely by a national or local government and executed jointly by a national or local government and a private enterprise.

The invention described in claim 7 provides the bond according to claim 1, wherein said public works are planned solely by a private enterprise and executed jointly by a national or local government and a private enterprise.

The invention described in claim 8 provides the bond according to claim 1, wherein said public works are planned jointly by a national or local government and a private enterprise and executed solely by a national or local government.

The invention described in claim 9 provides the bond according to claim 1, wherein said public works are planned jointly by a national or local government and a private enterprise and executed solely by a private enterprise.

The invention described in claim 10 provides the bond according to claim 1, wherein said public works are planned jointly by a national or local government and a private enterprise and executed jointly by a national or local government and a private enterprise.

The invention described in claim 11 provides the bond according to claim 1, wherein said bond issuer is a foundation established for urban developments.

The invention described in claim 12 is a new market forming method that encourages a new class of investors, those who have never previously been interested in such a bond, to purchase the bond described in claim 1.

The present invention provides a means of issuing bonds related to project financing, where projects are public works such as infrastructure improvement projects. A person who wishes to purchase such a bond is able to see the contents of the public works in which he is investing. Since the person can select the public works at will, in which his/her money is to be invested, this method enhances his/her desires for purchasing the bonds. Moreover, since the person's investment will never be used in public works to which he/her objects, the investor can purchase bonds with more confidence.

The present invention provides a private enterprise trying to execute public works such as infrastructure improvement projects a means of acquiring large sums of funds from private sectors to be invested into said public works such as infrastructure improvement projects through bond issuing. This is because those who are buying bonds can be assured for the repayment as the principal and interests repayment liabilities of the bond issuers are warranted to certain fixed limits by a national or local government so that the bond buyers are guaranteed to be able to collect the principal and interests safely to certain fixed limits even when the private enterprise fails in the operation of said public works.

Moreover, the present invention provides a means of preventing the national and local governments from wasting tax money, because the national or local government's warrant for the bond issuers' principal and interest repayment liabilities are limited to certain levels that are determined fairly by an independent public organization. Thus, the national or local government are not obliged to bear the full amounts of the bond issuers' principal and interests repayment liabilities when the operations of public works such as infrastructure improvement projects by a private enterprise fail as in the case of government guaranteed bonds. Furthermore, since the present invention encourages those who have never bought bonds to buy bonds, it forms a new bond market.

### BRIEF DESCRIPTION OF THE DRAWINGS

FIG. 1 is a view of a bond certificate according to an embodiment of the present invention.

FIG. 2 is a diagram showing development and operation of a public work (hospital) using the bond according to the embodiment of the present invention.

FIG. 3 is a view of an example of bond certificate based on the SPC Law.

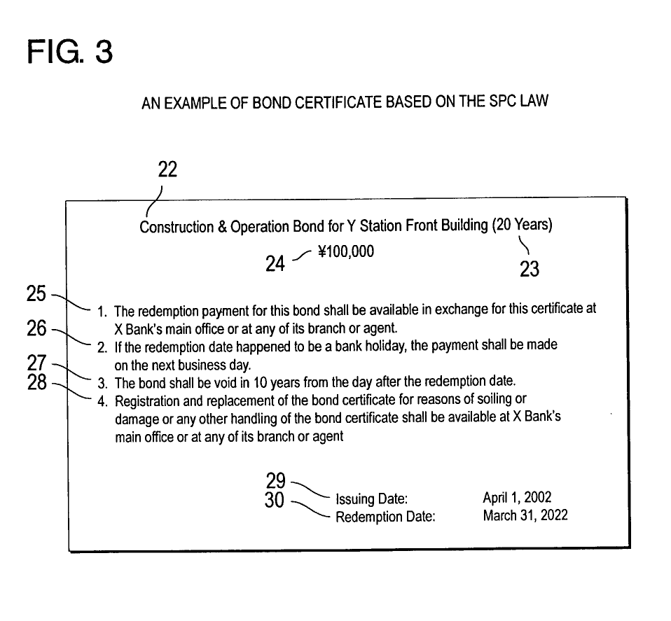

FIG. 4 is a diagram showing the scheme of PFI.

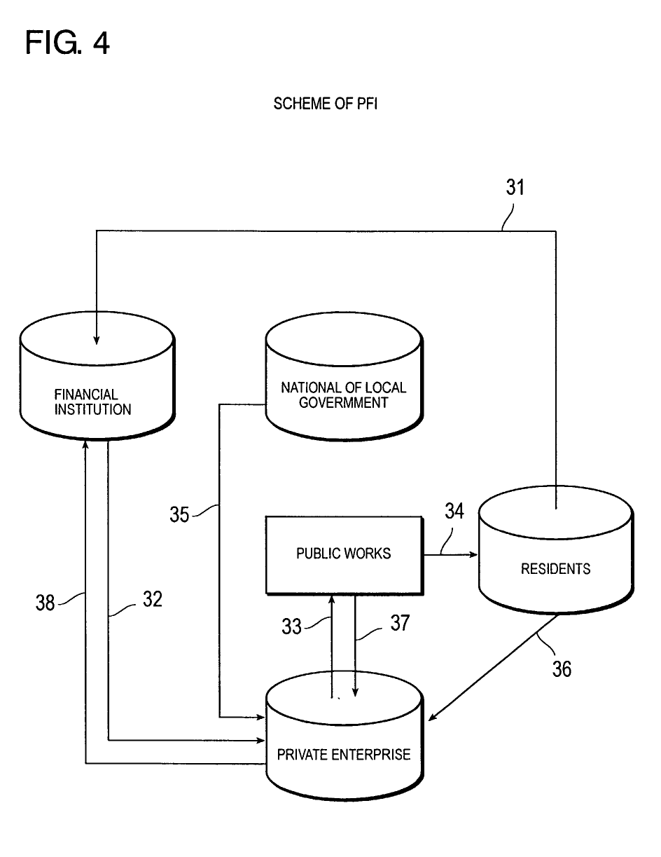

### DESCRIPTION OF THE PREFERRED EMBODIMENTS

A preferred embodiment of the present invention concerning a bond for acquiring private funds, in particular, for inviting private investments in public works such as infrastructure improvement projects will be described in detail referring to the accompanying drawings.

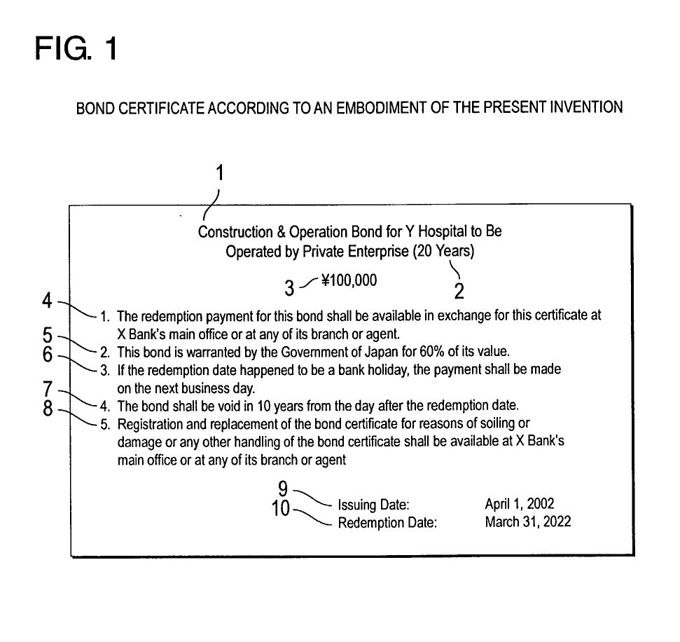

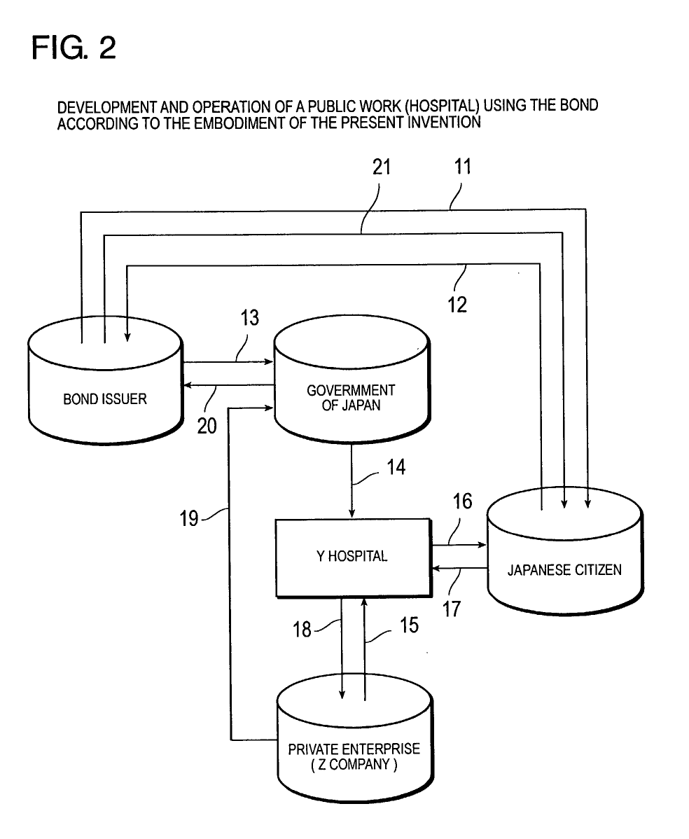

FIG. 1 is a view of a bond certificate according to an embodiment of the present invention. On the face of the bond certificate according to the present invention, a wording 1 of “Construction & Operation Bond for Y Hospital to Be Operated by Private Enterprise,” a wording 2 of “20 Years,” a wording 3 of “¥100,000,” a wording 4 of “The redemption payment for this bond shall be available in exchange for this certificate at X Bank's main office or at any of its branch or agent,” a wording 5 of “This bond is warranted by the Government of Japan for 60% of its value,” a wording 6 of “If the redemption date happened to be a bank holiday, the payment shall be made on the next business day,” a wording 7 of “The bond shall be void in 10 years from the day after the redemption date,” a wording 8 of “Registration and replacement of the bond certificate for reasons of soiling or damage or any other handling of the bond certificate shall be available at X Bank's main office or at any of its branch or agent,” a wording 9 of “Issuing Date: Apr. 1, 2002,” and a wording 10 of “Redemption Date: Mar. 31, 2022 ” are written. FIG. 2 is a diagram showing the development and operation of the public work (hospital) using the bond according to the embodiment of the present invention. The bond according to the embodiment of the present invention will be described below in detail referring to FIG. 2.

The wording 1 of “Construction & Operation Bond for Y Hospital to Be Operated by Private Enterprise” indicates that this bond is a bond according to the embodiment of the present invention. The wording 1 clarifies that the bond is related to operation by a private enterprise 15 (provides healthcare services to Japanese citizens 16 and collects healthcare fees 18). The wording 1 also clarifies that the bond is a bond issued with an intention of acquiring funds (11) for the construction of Y Hospital (14).

Therefore, a Japanese citizen who is buying (12) the bond can clearly understand from the wording 1 that the funds being acquired by the bonds are invested (13) strictly into the construction of the Y Hospital (14). Thus, the Japanese citizen who is buying the bond can have a clear sense that “my money will be invested for the construction of Y Hospital.”

Thus, according to this bond, contrary to other bonds where the buyers are not aware of what purposes the investments are used, the use of the funds acquired by the bond is clear so that the bond buyers' confidence can be enhanced, the bond buyers' desire for purchase can be increased, and ultimately promote investment of private funds to public works (13).

The wording 2 of “20 Years” indicates that the principal and the interest shall be redeemable (21) in 20 years from the issuing date. The wording 3 of “¥100,000” indicates the amount of fund (12) obtained by the issue of this bond. The wording 4 of “The redemption payment for this bond shall be available in exchange for this certificate at X Bank's main office or at any of its branch or agent” clarifies the locations of redemption. The wording 4 also clarifies that the principal and interest are paid in exchange for the bond certificate.

The wording 5 of “This bond is warranted by the Government of Japan for 60% of its value” clarifies that the Japanese government warrants (20) the bond issuer's principal and interest repayment liabilities to the Japanese citizen (buyer) within a certain limit. Although Z Company is liable to pay (19) to the bond issuer the cost of development of Y Hospital and its interest from the profit and revenue earned from the operation of Y Hospital (18) through the Japanese government, the operation of Y Hospital can deteriorate or fail.

However, the wording 5 warrants that 60% of the principal to be repaid by the bond issuer to the Japanese citizen (buyer). Thus, contrary to the bond based on the SPC Law, the bond buyers' confidence can be enhanced, and ultimately promote investment of private funds to public works (12). The warranty (20) by the Japanese government of the bond repayment liability is limited to a certain amount. Therefore, the Japanese government is not required to warrant the entire amount of the bond's principal and interests according to this bond.

The wording 6 of “If the redemption date happened to be a bank holiday, the payment shall be made on the next business day” clarifies the payment shall be made on the next business day as it is not clear when the payment (21) of the principal and the interest will be made if the redemption date falls on a bank holiday.

The wording 7 of “The bond shall be void in 10 years from the day after the redemption date” clarifies that the bond shall be void (21) after a period.

The wording 8 of “Registration and replacement of the bond certificate for reasons of soiling or damage or any other handling of the bond certificate shall be available at X Bank's main office or at any of its branch or agent,” clarifies how the bond certificate is handled in case of need for registration and replacement of the bond certificate for reasons of soiling or damage.

The wording 9 of “Issuing Date: Apr. 1, 2002 ” clarifies the issuing date (11). The wording 10 of “Redemption Date: Mar. 31, 2022 ” clarifies the redemption date (21).

The abovementioned bond is according to one of the embodiments of the present invention. Therefore, the bonds according to the present invention are not limited to the abovementioned bond. For example, the wording 1 can be anything as long as the particular bond is a bond related to a certain project finance, for example, they can be “Construction Bond for T Road Operated by Private Enterprise,” “Construction Bond for R Senior Citizen's Home,” and “Construction & Operation Bond for W Public Housing Project.”

Moreover, the degree of warranty of repayment liabilities by the national government indicated in the wording 5 is not limited to “60%” but rather can be any degree or ratio warranted by the a national or local government, for example, 10, 20 or 50%. Further, the entity that warrants the repayment liabilities in the wording 5 does not have to be “Japan,” but rather can be any country in the world such as U.S., China, Korea, and U.K.

Furthermore, the warranting government in the wording 5 can be any local government(s) in the world such as Tokyo, Osaka, Los Angeles, and Beijing. The buyer of the bond according to the invention is not limited to a Japanese citizen. A citizen of any country of the world, such as a U.S., Chinese, Korean and U.K. citizen can be a buyer of the bond according to the invention.

The “bond issuer” can be a foundation for urban development, or a similar entity.

According to the present invention, those who are buying bonds can be assured for the repayment as the principal and interests repayment liabilities of the bond issuers are warranted to certain fixed limits by a national or local government so that the bond buyers can have more confidence in buying the bond as they are guaranteed to be able to collect the principal and interests safely to certain fixed limits even when the a private enterprise fail in the operation of said public works.

As such, it is obvious that the redemption claim materializing after the due date for a bond issued according to the present invention is backed by strong credibility. Therefore, the present invention can be an effective means of cultivating unutilized funds held by private investors or citizens by providing unique bonds.

The bonds according to the present invention will encourage latent private funds in private sectors to be invested into public works. Therefore, the present invention will help the national as well as local governments of various countries of the world to improve infrastructures such as roads and healthcare facilities even under a tight financial condition.

The entire disclosure of Japanese Patent Application No. 2001-265178 filed on Sep. 3, 2001, including specification, claims, drawings and summary are incorporated herein by reference in its entirety.

It is to be understood that the foregoing disclosure taught and described herein is illustrative of the present invention. Modifications may readily be devised by those ordinarily skilled in the art without departing from the spirit or scope of the present invention.

What is claimed is:

1. A bond to be issued for the purpose of acquiring private funds to be invested in public works which include infrastructure improvement projects, characterized in containing a wording that a national or local government warrants the bond issuer's liability for the repayment of the principal and interest to fixed limit.

2. The bond according to claim 1, wherein said public works are planned solely by a national or local government and executed solely by a national or local government.

3. The bond according to claim 1, wherein said public works such as infrastructure improvement projects are planned solely by a private enterprise and executed solely by a private enterprise.

4. The bond according to claim 1, wherein said public works are planned solely by a national or local government and executed solely by a private enterprise.

5. The bond according to claim 1, wherein said public works are planned solely by a private enterprise and executed solely by a national or local government.

6. The bond according to claim 1, wherein said public works are planned solely by a national or local government and executed jointly by a national or local government and a private enterprise.

7. The bond according to claim 1, wherein said public works are planned solely by a private enterprise and executed jointly by a national or local government and a private enterprise.

8. The bond according to claim 1, wherein said public works are planned jointly by a national or local government and a private enterprise and executed solely by a national or local government.

9. The bond according to claim 1, wherein said public works are planned jointly by a national or local government and a private enterprise and executed solely by a private enterprise.

10. The bond according to claim 1, wherein said public works are planned jointly by a national or local government and a private enterprise and executed jointly by a national or local government and a private enterprise.

11. The bond according to claim 1, wherein said bond issuer is a foundation established for urban developments.

12. A method for marketing at least one bond according to claim 1 comprising an incentive means for encouraging an investor to purchase.

13. The method of claim 12 wherein the incentive means comprises the national or local government warranting of the bond issuer's liability.

14. The method of claim 13 wherein said at least one bond specifies a content of the public work to be performed and wherein the incentive means further comprises permitting the investor to purchase based on said content.
